(19) United States
(12) Patent Application Publication
(10) Pub. No.: US 2009/0217027 A1
(43) Pub. Date: Aug. 27, 2009

(54) Safe e-mail for everybody

(75) Inventor: Amir Ayalon, Tokyo (JP)

Correspondence Address: PATENT STRATEGIES, 11 ROSALITA LANE, MILLBRAE, CA, 94030, US

(73) Assignee: Zenlok Corporation

(21) Appl. No.: 12/072,006

(22) Filed: Feb. 21, 2008

(51) Int. Cl. H04L 9/00

(52) U.S. Cl. 713/150

(57) ABSTRACT

Like wearing seatbelts. Like using condoms. Security measures only work if done correctly and done all the time, but we don't use security measures when burden weighs more heavily than risk. That's why e-mail is rarely encrypted. Too difficult. Too costly. Balanced against little perceived risk in sending e-mails in the clear. Our simple, yet secure, e-mail encryption system changes that. It's easy to use—anyone who can use e-mail can use our encryption system. Users pay no charge for basic service—it's free. We make money in other ways. Other e-mail encryption systems cost too much, are too complex, need special hardware, and are not compatible. Ours is safe, easy, and free, and viral adoption can make our system the global standard for sending secure e-mails. With the privacy people get from our invisible, easy-to-use system, e-mail will be safe for everybody.

### FIELD OF INVENTION

We have invented a secure e-mail system providing safe e-mail for everybody.

### Outline

A. Introduction: E-mail At Risk

B: A Primer on Public Key Encryption
1. The Theory Behind Public and Private Keys
2. How to Use Public Key Encryption on E-mail
3. Secret “One-Time” Keys
4. Another Type of Public Key Encryption—Digital Signature Authentication
5. PGP and SSL

C. Why E-mail Encryption is Not Used
1. “Why Johnny Can't Encrypt”: E-mail Encryption Too Hard to Use
2. No Worldwide Standard Everyone Can Use
   a. Too many different systems, none work with the others.
   b. Too complex
   c. Too expensive to set up and maintain
   d. Often require hardware
3. E-mail Encryption Systems Not Profitable

D. How We Deliver Safe E-mail For Everybody
1. Safe, Easy, Free
2. Profitable
3. Allows E-mail to Be Used When Risk Is Not an Option
   a. Health care information
   b. Voting
   c. Social security numbers
   d. Lawyers and accountants
   e. Corporate information
   f. Government documents (even patent prosecution)
4. New Features Can Be Added
   a. Notice of message receipt
   b. Spam filtering
   c. Phishing prevention
   d. Identity verification
5. Burden Becomes Less than Risk

E. Possible Problems and Tradeoffs
1. Key Server Overload
2. New Threats and Attacks
3. Loss or Leaking of Private Keys
4. Encryption Not Used

F. Examples of Safe E-mail for Everybody
1. Try Our System
2. Use Open Source OpenSSLas the Base
3. Develop “Plug-Ins” for the Most Popular E-mail Clients
4. Make Encryption Easy
5. Free Public Key Server
6. Use “Viral” Adoption Techniques
7. Free for the Normal User
8. Fees for Upgraded or Ancillary Services
   a. Identity verification
   b. Faster responses from public key servers
9. Fees for Companies
   a. Master keys
   b. Mass mailing systems
10. Other Services

G. The Drawings

Claims

### Introduction: E-Mail At Risk

The Internet is not a safe place.

Eavesdropping. Confidence tricks. Identity theft. Spoofing. Phishing. Unwanted e-mail. Viruses. Worms. Time bombs. Intercepted business secrets. Corporate spying. Pedophiles trolling for victims. Hacking. Eavesdropping.

Danger does not mean the Internet can not, or should not, be used. We work out ways to handle risks. Decades ago many people didn't think twice about leaving their homes unlocked. Kids played freely in the streets. Yards were unfenced. People knew their neighbors—and often details of their family life and finances.

But things changed. People who left their homes unlocked found their property being stolen. The streets became more dangerous to children. Neighbors moved in and out more often. Outside of home, work and school, people began to keep more to themselves.

So we adjust. Almost everyone now uses locks. Many use security systems. Yards are fenced. Streets are now the province of cars, usually driven by strangers. Kids rarely use the streets alone. And people find it best to keep their family life and finances secret.

When we face risks, people adjust. We take security measures to make us, and our families, safe.

But with e-mail, that is a problem. E-mail has exploded. No one knows how many e-mails get sent every day. But whatever the number, it's staggering. Lower estimates seem around 60 billion worldwide. But some think we send over 160 billion e-mails a day. That number increases all the time.

And almost none of the billions of e-mails sent each day is secure. People are taking a big risk with their privacy—our e-mail can be intercepted and read as it travels from our computer to our recipient's computer. But we have not adjusted to that risk.

Why not? Why don't we take measures to make our e-mail safe? How can we handle the risk that someone will read, or worse yet steal, the contents of our e-mail?

Most importantly, how can we deliver safe and private e-mail for everybody? That is the question we look at, in detail, here.

### A Primer On Public Key Encryption

Very few people use encryption to send secure e-mails. Why not? That question we will return to later. But it is not because no encryption programs are available. Or that they cost too much. Although very hard to use, powerful public-private key encryption technology can be had for free. We will look here at how that technology works.

1. Public and Private Keys

Public key encryption is a special case of encryption. It operates using two keys: a private key and a public key. The keys have a special relationship. Used together, they let one person send a message that can only be read by one other person, the intended recipient.

This encryption system is called “public key encryption” because the encryption key can be published to the public. Both the public key and the private key are actually just big numbers (see FIGS. 1 and 2 for examples). But they have a special relationship.

What is the relationship? A special algorithm generates the two keys so that the private key can be used to decrypt messages encrypted using the public key. But even though the two keys have this special relationship, they are not similar to each other. In fact, the private key cannot be calculated from the public key. That is important.

A person makes public their own public key, so that everyone that may want to send them a message—can access this public key. That can be done by putting it on a public key server. Or by sending the public key to people who want to send an encrypted message. But each person keeps his or her private key very private. Only the private key can decrypt the message. FIG. 3 shows this.

Calling both the private and public keys “keys” may be confusing. Let's look at this another way. Think of the public key not as a key, but as a lock. And of the private key as the key that opens that lock.

For example, think of the public key as a combination lock that goes on the message. And the private key as the combination to the lock. A person will give out lots of copies of their combination lock—anyone who wants one can have one. But the person will keep the combination secret.

If someone wants to send the person a message, the sender puts the lock on the message. The sender does not need the combination to do that—they just put the lock on and fasten it. When the person gets the message, they use the combination to open the lock and read the message.

That's the way public key encryption works. Anyone can use the public key to lock a message. But only the recipient has the private key to unlock it.

But why go to all that trouble to use public key encryption?

Traditional cryptography systems work because both sender and recipient share a common secret key to code and decode a message. The problem is that someone might intercept the secret key as it is passed between the two parties. If the secret key is not kept private, anyone that discovers the key can read, modify, and forge the encrypted message. But if the secret key is kept private, it becomes very hard to get the key to people who want to use it to send messages.

The concept of “public key” was first developed in the 1970s to solve the problem of sharing a key over a network. Since everyone connected to the network can get the recipient's public key, anyone can send them a message by encrypting it with that public key. Only the recipient can read the message by decrypting it with his or her private key. There is no need to exchange a secret key. The risk of exposing the message decreases.

The goal of public key encryption is to have an easy way to implement the encoding using virtually unbreakable codes. Three people—Rivest, Shamir, and Adleman—did fundamental work on this problem. Now called RSA encryption, after these three, the system relies on public and private keys that have a special mathematical relationship. We won't go into the mathematics here—we will just say that it involves the prime factors of very large numbers.

But one central concept should be remembered. Even if you have the public key, you will have a very tough time finding a key that will decrypt a coded message, even using today's fastest computers. That is due to the large amount of work involved. In practice, for now, it is impossible.

2. How to Use Public Key Encryption on E-mail.

Let's look at a few examples of how this works. First, say that you want to receive a secure e-mail from your attorney. You first need to make sure she has your public key. You could send it to her. Or you could make sure that your public key is on a server that anyone can access.

The public key is public—you don't need to keep it secret. Anyone can have it. In fact, anyone who wants to send you encrypted e-mail will need that public key to do it.

Your attorney's encryption program then uses your public key to encrypt her e-mail to you. The public key can be used only to encrypt messages. It cannot be used to decrypt them. So no one can use your public key to decrypt your attorney's message. They would need your private key. That they should not have. The private key should be kept secret on your computer. No one else needs it. No one else should have it.

Once your attorney sends you her message in encrypted form, your encryption program uses your private key to decrypt the message. Decrypting a message encrypted with a public key can only be done with the matching private key. That is why the two keys form a pair. That is also why it is so important to keep the private key safe. To make sure it never gets into the wrong hands (or in any hands other than yours).

For another example, say that you want to send an e-mail to two different people. You need a public key to encrypt the e-mail. In fact, you need two public keys—both people that you want to send a message to need their own public key. Each public key will correspond to a different private key.

One crucial point—public key encryption only works if the sender of a message can be sure that the public key used for encryption belongs to the recipient. A third party can produce a public key with the recipient's name and give it to-the sender, who uses the key to send important information in encrypted form. The enciphered message is intercepted by the third party. Since the message was encrypted using the third party's public key, he or she will have no problem deciphering it with his or her private key.

So you need to make sure that you have the right public key for each person. You can be pretty sure about that if the public key is either given to you personally or authorized by a certificate authority.

Once you have the right public keys, your encryption program uses both public keys to encrypt your message. Your e-mail program sends the encrypted message to each of the recipients. Each recipient's encryption program then uses his or her matching private key to decrypt the message. Message received—the system works.

Simple enough, right? Each intended recipient of a message needs a public key and a private key—a matching set. The public key is public. The private key is private. Messages are encrypted using the public key, and decrypted using the private key. As long as the public key is really the recipient's public key, and the private key is really private, the system works. Messages are secure.

In reality, it's not quite that simple. We will look next at one more step that we take (as others also often do) to make the system faster and more practical. And problems often have to be worked out to make the system work. We will talk about some of those problems, but not all of them. For now, though, we will leave the basics of public key encryption at that.

3. Secret “One-Time” Keys

One problem comes up with public key encryption. Using a public key to encrypt a message will take a lot of computation for a lengthy message. Same with using a private key to decrypt it. The time can be quite long—certainly long enough to make it impractical for most people.

One solution works pretty well. If a secret “one-time” key can be securely exchanged between the sender and the recipient, even a lengthy message can be encrypted and decrypted quickly. The thing that makes public key encryption take so much computation is the nature of the public and private keys. Their matching characteristic makes the system work, but it also makes for complex computing. A one-time key is, by comparison, simple.

So we can do this. Use the public key to encrypt a secret one-time key. Then use that one-time key to encrypt the message. Send the encrypted one-time key and the encrypted message to the recipient. The recipient's encryption program uses its private key to decrypt the one-time key. Then it uses the one-time key to decrypt the message. All that can be done quite quickly.

Most public key encryption programs use this secret one-time key solution to keep processing time short. It won't matter much with a short e-mail message. But attach a longer document to the e-mail, and the computation gets very heavy very quickly. A practical system really needs to use secret one-time keys, or something similar.

4. Another Type of Public Key Encryption

Digital Signature Authentication

One other problem with basic public key encryption—everyone knows the recipient's public key. Anyone can pretend to be another sender and send a forged message to the recipient encrypted with his or her public key. Fortunately, digital signature authentication provides a solution to this problem.

Before sending a message, a sender can encrypt it with his or her own private key. The recipient can decrypt the message using the sender's public key. The entire message prepared by the sender is referred to as being digitally signed. (Note that this is backwards from the usual pattern, where the public key is used to encrypt and the private key to decrypt.)

Since only the original sender has his or her own private key, no one else can prepare the sent message. That's one big advantage over a handwritten signature. This property allows a prepared message to be authenticated in terms of both its contents and its data integrity.

On the other hand, digital signature authentication has a disadvantage. The sent message, encrypted with the sender's private key, can easily be intercepted by anyone who has the sender's public key. Therefore, the message is almost transparent and accessible by anyone on the network.

One remedy to this problem is to use the key exchange method of the public key system. Just before a sender sends the digitally signed message, they can encrypt it again with the recipient's public key. The recipient then has to decrypt the message first with his or her own private key, then decrypt it again with the sender's public key.

In this way, the sent message is much more secure because no one but the recipient has this private key to decrypt the message, and secure in terms of authentication because no one but the sender has this private key to prepare the sent message. This is one of the most secure methods to communicate within a network.

5. PGP and SSL

Both free and paid programs use cryptographic signatures (e.g., PGP “Pretty Good Privacy” or other encryption technologies) to exchange authenticated e-mail messages. Authenticated e-mail provides a mechanism for ensuring that messages are from whom they appear to be, as well as ensuring that the message has not been altered in transit.

As a free software package, Pretty Good Privacy (PGP) will encrypt and decrypt messages. PGP is a protocol for encrypting files and e-mail. It depends on public key cryptography for its effectiveness. Using one of several available commercial or free software applications, a person can generate two digital IDs or keys, one public and one private.

The public key is shared with anyone who needs to send encrypted data to the owner of the key. The private key is guarded by the owner and, in conjunction with a strong passphrase, is used to decode encrypted messages. This system depends on senders and recipients performing a one-time corroboration of the authenticity of their identities, their trustworthiness, and their keys' “fingerprints.” GNU Privacy Guard (GnuPG or GPG) is a free software replacement for PGP, with the same core encryption functions.

But using PGP, or its newer version GPG, is not easy. You need more than just a cursory knowledge of public key encryption. You need to know what you are doing. And you need to spend a fair amount of time setting up keys and the other things needed to make PGP or GPG work.

### Why E-mail Encryption is Not Used

Of the billions of e-mails sent and received every hour, almost none are encrypted. More than 99.9% of the e-mails are sent “in the clear.” Yet state-of-the-art e-mail encryption programs can be downloaded from the Internet for free. And these programs are not new—they have been around for years.

Why don't people use these programs to encrypt their e-mails? Let's look at some of the reasons.

1. “Why Johnny Can't Encrypt”: E-mail Encryption Too Hard to Use

In a 1999 paper “Why Johnny Can't Encrypt,” computer scientists Alma Whitten and J. D. Tygar argue that ordinary people cannot use e-mail encryption software. Using Pretty Good Privacy (PGP), only 4 out of the 12 people in the study could encrypt an e-mail message in 90 minutes. Even with help. One quarter of the people failed completely, sending the secret e-mail in clear text.

The two scientists concluded that the complexity of e-mail encryption requires a system to be better than other programs. Very easy to use in spite of its complexity. Otherwise, normal people cannot use it.

Encryption software can be thought “usable” if people who are expected to use it:
are reliably made aware of the security tasks they need to perform
are able to figure out how to successfully perform those tasks
don't make dangerous errors
are sufficiently comfortable with the interface to continue using it

According to this 1999 study, encryption programs fail this test. The 1999 study used version 5.0 of the PGP program. Whitten and Tygar gave PGP 5.0 pretty high marks for its attractive graphical user interface. Still, eight years later, in 2007 four other computer scientists gave a paper based on a study with the much-improved PGP 9.0. Its title was “Why Johnny Still Can't Encrypt.” The problem remains.

And yet, one poll found that privacy is the biggest concern when using the Internet. Using privacy technology may be like using condoms and wearing seatbelts. The benefit should be considered much greater than the hassle. But it's not.

People say they're concerned about privacy and security, but they don't want to do anything about it. Any difficulty with the process and they give up. The message goes out in the clear, risk or not.

To be used, e-mail encryption has to be easy to use. For e-mail encryption program designers, making a complex system that easy has been hard.

2. No Worldwide Standard Everyone Can Use

Every e-mail message has a sender and a recipient. For e-mail encryption, both the sender and the recipient need the same encryption program on their computer for the system to work. Today, that's a problem. It rarely happens.

a. Too Many Different Systems, None Work with the Others.

Many e-mail encryption programs are available. Too many. PGP, GPG, Ize-mail, SecureZIP, Hushmail and others vie for acceptance. Encryption of a sort is already built into programs like Microsoft Outlook, Microsoft Outlook Express, and IBM's Lotus Notes. But not even one user in a thousand uses any encryption program at all. So none of these encryption programs has captured more than a sliver of the e-mail encryption market.

And none of these systems works with the others. One standard for encrypted e-mail has developed. Based on the work of Phil Zimmerman, who released the first version of Pretty Good Privacy (PGP) in 1991, the OpenPGP standard (otherwise known as RFC 2440) probably has the most market share. Still, compatibility between systems is limited. Technical support in trying to get two systems working together will be difficult, if not impossible to find.

So in practice if not in theory, both the sender and the recipient have to use the same program to exchange an encrypted e-mail. The chances of that happening now, without one or the other having to download a new program before sending or receiving an e-mail, are very small.

So the base of e-mail encryption users is tiny. And even that tiny base is fragmented. That gives a very weak base for a worldwide standard to develop. So far, there is no sign that use of e-mail encryption is increasing. Even Phil Zimmerman, who developed PGP and gave birth to e-mail encryption, said in a 2006 interview with National Public Radio that he uses encryption “only occasionally.”

b. Too Complex

E-mail encryption is complex. We talked above about the reasons “why Johnny can't encrypt.” The complex theory behind public key encryption does not make it easy to use. Most of the encryption systems available are much too complex for the average user to understand. And that helps keep a worldwide, universal standard from developing.

But the designers of PGP, for example, know this problem. Beginning with PGP 5.0, they made big improvements to usability. PGP had been a difficult program to use, even by general consumer software standards. Its designers now made sure that the PGP graphical user interface was as good as Windows and Word and other software programs used by computer novices.

That did not solve the problem. The goal was for the “significantly improved graphical user interface [to make] complex mathematical cryptograph accessible for novice computer users.” As the “Why Johnny Can't Encrypt” study found out, 3/4 of the people in the study still could not use the program correctly, even in 90 minutes for a single e-mail and even with help. More needed to be done to make PGP work for everyone.

And other things were done. Wizards and tutorials were developed. They do not seem to make much of a difference. When people have to learn how to use encryption, they don't bother. Instead, the risk is taken. Messages get sent in the clear.

Some experts believe that e-mail encryption will need to be automatic, sent at the click of a button, before it will be used by anyone other than security specialists. One reason is that most of the encryption systems give the user too much information to make sense of. That gives the user flexibility, but at a tradeoff of complexity. That tradeoff does not seem to work.

c. Too Expensive to Set Up and Maintain

Because of the complexity, e-mail encryption systems tend to be expensive to set up. If a company installs encryption on its internal systems, a license needs to be purchased for each person. Updates need to be kept track of. So do keys. Help desk assistance needs to be on call. And with most systems, lost messages or messages that cannot be decrypted will add to the cost of doing business.

One encryption company executive told how hard it was to set up an e-mail encryption system at a company. “It was a completely manual process. You had to buy a bunch of servers, hire a bunch of staff and train them. You had to go out and get certificates, which were purchased from a company like VeriSign. Then, you had to manually hand them out to all employees. Once you had all the infrastructure together, you still did not have any applications. You still had to go out and train your users on how to use e-mail encryption at the desktop client level—when it was to be used, how to find keys, etc. It was just too hard.”

Things have improved since then. But not enough to make many companies invest in e-mail encryption.

d. Often Require Hardware

Many e-mail encryption systems require that special hardware be installed in the organization's network. That adds to the expense of setting up and maintaining the system. Compatibility between the special encryption hardware and the network can be a sticky problem. Technical support in those cases can be difficult to find, and will be expensive.

Special hardware also makes it more difficult (and expensive) to move a system out to different branches of a company. Scaling a system up or down—as needs change—also becomes more difficult when special hardware is involved.

3. E-mail Encryption Systems Not Profitable

Not many people use e-mail encryption. Without a large user base to profit from, encryption companies need to charge the few users more to make any money. But users have not been willing to pay much, if any. Users will not do much or pay much before they will decide instead to take the risk of sending e-mails in the clear.

That makes it hard for an e-mail encryption company to make money. If you offer a free, easy-to-use program, you can probably build a big base of users. But making the program easy to use means spending a lot of money on development. If you then make it free, how do you make money?

That problem may well be why no e-mail encryption companies have built a base of users. Not enough money in it. And that can be a hard problem to solve.

### How We Deliver Safe E-mail For Everybody

We have invented an e-mail encryption system that delivers safe e-mail for everybody. Particularly for those e-mail messages where risk is not an option. Although our invention can take many forms, we think that in many of those forms our system can do things much better than the competition:
Our system is available for free.
We plan to support a very wide base of e-mail clients.
Ours is the easiest e-mail encryption software to use and install, requiring only that a user knows how to send and receive e-mail.
Our users can send encrypted e-mail to non registered users with ease.
Non-registered users can receive encrypted e-mail, and within minutes be able to send and receive the same.
Our system offers significantly better protection than the commonly used zip/password method of protecting files sent via e-mail.
We provide much needed security for companies that use a hosted (ASP) corporate e-mail solution.
We offer an identity verification process second to none.

Let's look at some of those advantages in more detail below.

1. Safe, Easy, Free

We have made our e-mail system easy to use. People don't use encryption because it's too hard to use it. You need a good grasp of how encryption works to use it. With our system, you don't. If you know how to use your e-mail program, you can use encryption with our system.

We are not the only ones who have realized how big a barrier ease of use is to wide use of e-mail encryption. Others have also realized this, and have made their systems easier to use. But that is easier said than done.

Making sure that an encryption works well, with full functions, and still is easy to use takes a great deal of effort. Some tradeoffs must be made. To get ease of use, you have to give up some flexibility, limiting options.

Think, for example, of automatic transmissions in cars. Manual shifting gives better performance and better fuel efficiency (for all but unskilled drivers). Automatic shifting gives up performance and efficiency. But it gives great convenience. Automatic transmissions have improved over the years too. To the point where now automatic transmissions have become standard.

We have made ease of use our top goal. That requires some tradeoffs, in flexibility and in strength of security. But we think they are worth making. One of the problems with security of all types is balancing ease of use against security. If you have a diamond necklace, the safest place for it is in a bank vault. But if you keep it there all the time, why have it? Better to minimize risk while still enjoying your jewelry.

Tradeoffs are not the only problem. Making encryption easy to use takes a lot of development effort, which costs money. Paradoxically, hard to use systems are the easiest to make. Like Dolly Parton says, “It costs a lot of money to look this cheap.” Same with ease of use for encryption software.

One of our advantages, therefore, is how easy our software is to use.

2. Profitable

We have developed revenue sources and pricing that will let us make money. Even so, we plan to let users send and receive encrypted e-mails for free. Our plug-ins for the common e-mail programs can, in principle, be downloaded for free.

While we will work with our business model to balance free use against revenue sources, our general principle is to offer basic encryption for free. Just like searching can be done on Google and other search engines for free, our users can send and receive encrypted e-mails for free. This will encourage people to use our system. And we can (we hope) be as profitable as a Google.

This is like Adobe providing PDF readers for free. Build a huge user base, and there are opportunities for making money.

One of our advantages, therefore, is that we can make money from our system.

3. Allows E-mail to Be Used When Risk Is Not an Option

We use e-mail for many things. Few people use encryption, though. And that limits what e-mail can be used for. Even normal e-mails are at risk of being intercepted and read. When risk is not an option—for sensitive information—e-mails are not sent. With our e-mail encryption system, e-mail can be used to send sensitive information.

This is the golden age of wiretapping. The Internet has so much information available on it that people have every incentive to steal it. An electronics store will lock up small, valuable video games in a case so they do not walk out the door in someone's pocket. Unless sensitive information is protected, people will steal it. Up until our system, the best way to protect sensitive information was to not put the information in an e-mail. Simple, effective, but very limiting.

One of our advantages, therefore, is that e-mail can be used for more things.

a. Health Care Information

Around the world, governments have stiffened the privacy requirements around health information. In the United States, the Health Insurance Portability and Privacy Act (HIPPA) required doctors to treat the health information of their patients carefully. Regulations under HIPPA require any e-mails that contain that kind of information to be encrypted.

In the European Union, privacy concerns tend to be even more important than in the United States. Many still remember how the Nazi government in Germany gathered information about race, religion, and physical and mental health, and then used that information to kill. Doctors and hospitals using patient information in European countries need, at least, to encrypt any e-mails that contain it.

b. Voting

Government officials and public policy groups in the United States and Europe have looked into voting by e-mail—sometimes called e-voting. Done securely, voting by e-mail in government elections could save voters time and governments money. It could increase the number of people who vote.

But voting by e-mail requires strong security measures. If e-mail encryption becomes widespread, voting by e-mail could work, and work well.

c. Social Security Numbers

Identity theft has become a crime that many worry about. Use of social security numbers in unencrypted electronic files leads to many cases of identity theft. Government agencies and financial institutions warn people not to use their social security numbers in e-mails.

If e-mails are encrypted, social security numbers could be used in e-mails. That opens the way for tax filing, social security matters, and other government functions to be done by e-mail. Right now, the biggest user of encrypted e-mail is the government. Even so, very few government communications are encrypted.

d. Lawyers and Accountants

Lawyers and accountants deal with sensitive information all the time. Many times confidential information gets sent by e-mail without being encrypted. The convenience and speed of e-mail makes it too tempting to pass by. Yet encryption takes so much bother it is not used. So risks are taken.

In most cases, nothing bad happens. In more and more cases, problems do occur. And they can be big problems. Insurance carriers have begun to look very carefully at the risks that law firms and accountants take in sending e-mail.

Were e-mail encryption convenient and widely used, with a global standard, sending business communications in the clear would be seen as unprofessional and careless.

e. Corporate Information

By law and regulation, the federal government has cracked down on corporations. After the Enron scandal, and other areas where corporations have been lax, the government has stepped in to set a bar that corporations must meet in handling sensitive information. So far, encrypting e-mail has not been required. That may change.

On the state level, Nevada recently (in 2008) took this farther than any other state. Nevada already requires a company to report any unauthorized access or acquisition of its customer information. Even when that law has not been triggered, in 2008 merely transmitting customer information in an unencrypted format may violate a separate Nevada data security law.

Nevada has enacted a data security law that mandates encryption for the transmission of personal information. Specifically, the Nevada encryption statute generally prohibits a business in Nevada from transferring “any personal information of a customer through an electronic transmission,” except via facsimile, “unless the business uses encryption to ensure the security of electronic transmission.” The Nevada encryption law goes into effect on Oct. 1, 2008.

The “personal information” covered by the Nevada encryption law is the same information that is subject to that state's security breach notification law. That is: “a natural person's first name or first initial and last name in combination with any of the following:
social security number or employer identification number;
driver's license number or identification card number; or
account number, credit card number or debit card number, in combination with any required security code, access code or password that would permit access to the person's financial account.”

Nevada is not alone in requiring tight security for personal information. For example, the California Security Safeguard Act applies to a company that owns or licenses unencrypted “personal information” about California residents. It requires the company to implement and maintain “reasonable security procedures and practices” to protect the information. Texas and Rhode Island have also passed laws that require companies to protect sensitive information about their customers.

But so far, only the Nevada encryption law requires encryption, rather than just some unnamed “reasonable” security procedure. So Nevada stands alone on this for now. But it may signal the beginning of a trend.

Were there a global standard for e-mail encryption, corporations would be able to enjoy the convenience and low cost of communicating by e-mail without a high risk of the privacy of their customers being violated.

f. Government Documents (Even Patent Prosecution)

Many government agencies use the regular mail, or faxing, when e-mail would be cheaper and faster. That is often because e-mail is not secure. In prosecuting this patent, for example, it would be easier for us to communicate with the patent office by e-mail. And that is allowed. But only if the patent applicant files a statement in writing agreeing to waive any complaint if the secrecy of the communication is breached.

E-mail encryption would open the gates for a flood of e-mails to replace much of the flood of regular mail—and all the paper that goes into it—in normal government communication.

4. New Features Can Be Added

Several growing e-mail trends can be aided by adding new features to basic encryption. Our e-mail for when risk is not an option allows us to meet trends like:
privacy and compliance
e-mail security (phishing, spam)
outsourced corporate e-mail
identity verification

One of our advantages, therefore, is that new features can be added to basic encryption to respond to customer needs.

a. Notice of Message Receipt

One big problem with e-mail—you rarely know if the person you sent the e-mail to actually got it. You can ask for a return receipt, and some people do send one. Even if you do ask, though, you cannot be sure that one will be sent. There are some tradeoffs to consider. We can add notice of message receipt in a way that does more than currently offered by e-mail clients like Microsoft Outlook Express.

b. Spam Filtering

Our e-mail encryption system lets us add spam filtering. No one with an active e-mail account needs to be told about spam. Reducing the number of spam e-mails will be a godsend. We cannot solve the problem of unwanted e-mails, but we can help.

c. Phishing Prevention

Like the term spam, the term phishing had to be developed to describe an abuse of the Internet. Phishing (pronounced fishing) is a scam where e-mail is sent that links to false, but genuine looking web sites. Most bank e-mails are imitated, and the sender tries to steal personal information. The spam bait is used with the odds that it will be ignored by most, because it will be out of context. But some may be hooked, or “phished.” At least that is the hope of the sender.

Our e-mail encryption lets the recipient identify, with a high degree of trust, the sender of e-mails. That helps prevent phishing.

d. Identity Verification

Verifying the identity of the sender helps with phishing, but that is not its only value. If an e-mail can be linked to a proven identity, business transactions and government communications become possible through e-mail. Without proven identity, use of e-mail is constrained.

Our e-mail encryption can offer features not possible with the current incompatible e-mail encryption systems, each with limited number of users.

5. Burden Becomes Less than Risk

In his book Secrets and Lies, security expert Bruce Schneier notes a basic contradiction. The world is a dangerous place. Yet the world is a safe place. Crime, death and disaster happen to some people, somewhere, every day. But for almost everybody, almost all of the time, none of the big bad things happen. Most days, for most people, are safe.

The same is true of e-mail. Your e-mail can be intercepted and misused. It happens all the time. The risk is real. On the back cover of another book by Bruce Schneier, he asks:

“Who can read your mail? The competition? A reporter? Your boss? The world of e-mail is the world of postcards. Between you and your correspondents may lurk a foreign government, a business competitor, an overzealous law enforcement agency, or even just a nosy neighbor! The problem is, all of these potential eavesdroppers, given fairly simple access tools, can read your messages as easily as a postal worker can read your postcards.”

And it's not just the bad guys who read your e-mail. If you use G-Mail, then Google scans the contents of any e-mail you open. Google does that to decide what advertising to put on your G-Mail page when you read the e-mail. Other Internet e-mail providers do the same.

Again quoting security expert Bruce Schneier, “security is a trade-off. When we brush our teeth in the morning, we're making a security trade-off: the time spent brushing in exchange for a small amount of security against tooth decay. When we lock the door to our home, we're making a security trade-off: the inconvenience of carrying and using a key in exchange for some security against burglary (or worse). When we reach down at a checkout counter to buy a candy bar and notice that the package has been opened, why do we reach for another? It's because a fully wrapped candy bar is a better security trade-off, for the same money, than a partially wrapped one.”

With e-mail security, people are not willing to make the trade-off to get the security of encryption. The price of encryption, in complexity and bother, is just too high. Most people probably prefer to keep their e-mails private. But when the price of privacy is too high, people take risks with it. With e-mail, that is what happened. To protect your e-mail privacy, you have to learn about encryption and take the trouble to work with keys. Few do that. Most take the risk.

We change that. Our e-mail system is safe, easy and free. Balanced against the risk of other people reading and misusing one's e-mail, that's not a very high price to pay. Not very high at all. We think almost everybody will pay it.

That will make sending encrypted e-mail like brushing your teeth. Like locking your house and car. Like putting back an opened candy bar and taking a sealed one instead. When the risks outweigh the burden for most of us, and adoption of our system spreads virally, we will have what encryption promised to deliver, but so far has not: safe e-mail for everybody.

### Possible Problems And Tradeoffs

Our system providing safe e-mail for everybody improves on current systems. But that's not because we are smart and everyone else is stupid. E-mail encryption poses problems for everyone. Problems that are not easy to solve. And tradeoffs often need to be made.

As hacker turned security expert Kevin Mitnick notes, no security system is perfect. Here are some of the problems and tradeoffs that need to be considered when designing a system that delivers safe e-mail for everybody. Note that we can make changes to our system to address these issues. The claims in this patent define our invention. As long as we stay within the scope of those claims, we can change the tradeoffs we make.

For instance, we now use a central public key server. That is more convenient, and we think more secure. But at least one expert (as we discuss below) thinks differently. We may decide that having several public key servers distributed around the world may be more secure and just as convenient.

1. Key Server Overload

If many billions of e-mails are sent encrypted each hour, success may be hard to handle. Our public key servers will need to handle a huge load. We need to make sure that our pricing and business model will support the maintenance of that many servers. And that our software can scale to the load without crashing. The public key servers crashing would be a big problem.

2. New Threats and Attacks

Encryption can make us more vulnerable to new risks and threats, according to security experts. Threats and attacks that used to be on the e-mail messages themselves shift instead to the key management infrastructure.

Risks can be both accidental and deliberate. You might turn out to be the culprit yourself. As one expert points out, “when you encrypt your e-mail messages and then lose the key, you have trashed your e-mail—it's a self-inflicted denial-of-service attack.”

Or hackers could be the attackers. Another security expert noted that “it's a new class of denial-of-service attack. If you can go in and revoke a key and then demand a ransom, it's a fantastic way of attacking a business.” Without encryption, that particular threat does not exist.

Any encryption scheme will be attacked by hackers. We need to be careful to make our design as hacker-proof as possible. But within reason. Usability has to be balanced with security. One cannot be emphasized too much over the other.

One concrete example. One security expert, Bruce Schneier, thinks that a system with a central public key server—like one example of our system—will be more vulnerable to attack by criminals than the current system with many different public key servers. He points out that centralized systems are more valuable targets, giving hackers a strong incentive to outwit the security behind them. He thinks we are more secure with many key servers scattered around the world.

Risks and security have always been in an uneasy balance. New security systems make us more secure for a while. But new threats will always be born in response. In fact, one security company executive notes that “sometimes the result of implementing security technology is actually a net increase in risk.” That's something we need to keep in mind.

3. Loss or Leaking of Private Keys

One problem with security is that people forget passwords and lose keys. That can be devastating, resulting in e-mail messages that cannot be decoded. Phil Zimmerman, the inventor of Pretty Good Privacy, says that people have come to him literally crying for help. They want him to find a way to decrypt important files for which the key has been lost or the passphrase (a several word-long password) forgotten.

Zimmerman tells them that the only person who can help them is a psychiatrist, to help them deal with their loss. The point of an unbreakable code is that it cannot be broken. If the key is not available to decode the file or message, the file or message is lost.

So encryption can cause bigger problems than it avoids. For example, if a user makes any of the following mistakes, their encrypted e-mails might be forever lost:
accidentally deleting the private key
accidentally revoking a key
forgetting the passphrase
failing to back up a private key

In these cases, the cure of encryption may be worse than the disease of lost privacy. We need to take steps to help our system users avoid mistakes like these.

4. Encryption Not Used

Most people do not give much thought to securing their lunch in the company refrigerator. There is a threat of theft. But the risk is not significant. Thefts are rare. And the occasional loss of a lunch is not a big deal.

People will complain if they lose their lunch. But they will probably not do much else. The safety of keeping a lunch in the refrigerator and the convenience of using the company refrigerator outweigh the risk of a lost lunch.

Will people encrypt their e-mails? The benefits of encryption may have been oversold in the past. We were told that we would all be safe and secure in our communications thanks to the magic of advanced encryption algorithms. Several very successful public stock offerings (those of VeriSign and Entrust, for example) and dozens of startups funded by eager venture capitalists seemed to show that people would pay to encrypt their e-mails.

But then reality set in. Malevolent snoops are not spying on our every e-mail conversation. If they were, we would be seeing lots of e-mail content posted all over the Internet. We don't. True, most Internet service providers can read your e-mail. But they have few incentives to do so, and lots of incentives not to. And the volume is so high it gets expensive.

So encryption as an industry hit the wall of market reality. People did not create any demand (or see any need) to protect their every-day e-mail communications. Certainly not enough to warrant the bother of encryption—particularly having to store or remember all those keys or passphrases. Sensitive information was just not sent by e-mail.

Encrypting computer files has become more common. Government regulations now stop just short of requiring encryption. California passed SB 1386 which requires companies to disclose when unencrypted personal information is lost or exposed. This has created a swell in demand for systems that can encrypt files of social security numbers and credit card numbers. But e-mail encryption has still not become common practice.

That may change. The American telephone giant ATT has teamed up with the United States government National Security Agency to develop an automated system that can “sniff” network traffic at high speeds and intercept communications. If the government can do it, so can others. E-mail privacy is threatened. Encryption can remove almost all of that threat.

Another reason to encrypt e-mails is to free up e-mail to do more. Using e-mails to send secure communications will break the need to use slower, paper-based communications for sensitive information. Cheaper, faster, more secure communication will always help.

But we need to be sure that our e-mail system brings much more benefit than cost. Otherwise, it too will not be used by more than a tiny sliver of users.

### Examples of Safe E-mail for Everybody

Here we give examples of safe e-mail for everybody.

To avoid any doubt, though, we should emphasize one thing. This is a patent. In a patent, this discussion does not define the invention. Only the claims do. This discussion is intended only to help interpret the claims, not to limit them. In case of a conflict between this discussion and the claims, the claims govern.

1. Try Our System

Anyone who can send e-mail can try our system by getting a plug-in for their e-mail client from www.zenlok.com. To use the program on Mozilla Thunderbird, for example, do the following:
Download the plug-in onto your hard disk.
In Thunderbird, open “Add-ons” from the Tools menu.
Click the Install button, and locate/select the file you downloaded and click “OK.”
Restart Thunderbird.

In particular, we specially invite the examiner to use the encryption offered by our invention to send confidential e-mails to us regarding this patent application. Normal e-mail is a confidentiality risk. E-mail sent using our system is for cases like patent office communications, when risk is not an option.

2. Use Open Source OpenSSL as the Base

Thanks to Phil Zimmerman and others, state-of-the-art public key encryption technology can be freely used. Some versions of Pretty Good Privacy are freeware. Other programs can also be used for basic encryption functions. In this example, we use OpenSSL as a platform.

3. Develop “Plug-Ins” for the Most Popular E-mail Clients

In this example, using our encryption requires no special knowledge on the part of the user. To make encryption easy for users, we make the encryption part of a “plug-in” for the most popular e-mail clients. FIG. 4 shows how our system comprises users, software for existing e-mail clients, and a key server. FIG. 5 shows the key and message flow.

After installation of a plug-in, icons and toolbars for our system will appear in the toolbar of the user's e-mail client (see FIG. 6 for an example of how this might look to the user).

In this example, we make plug-ins for the following clients (running on the platform shown):
Microsoft Outlook 2000, 2003, 2007 (Windows XP, Vista)
Outlook Express (Windows XP, Vista)
Web Mail (a standalone application that can support e-mail applications like Hotmail and G-Mail on Windows, Mac and Linux platforms)
Thunderbird (Windows XP, Vista, Mac, Linux)
Becky (Windows XP, Vista)
Apple Mail (Mac)
IBM Lotus Notes (Windows)

The more e-mail clients supported, the more people who will be potential users of our system. So we will add to the list if any new client becomes popular.

4. Make Encryption Easy

In this example, two guidelines must be followed in developing the plug-ins:

First, the encryption technology must be transparent to the user—like anti-virus—and just happen in the background. It must be managed centrally and based on policies. Dependence on the user to use advanced encryption does not work. That means that once downloaded, the encryption program automatically installs itself into the user's e-mail client (which may be Outlook Express, Thunderbird, or the like). And that once installed, encryption options appear in the e-mail client's toolbar.

Second, the encryption technology must fit on top of the e-mail infrastructure, without being disruptive. A user must be able to send and receive encrypted messages either automatically, or with “one click” of the computer's mouse.

All client software will be multilingual capable (in terms of handling e-mail content) and at a minimum, support English and Japanese in the user interface. Once we have a proven solution and user base in Japan, we will rapidly expand the client to support multiple additional languages.

We plan to offer the identity verification service (“trusted users” ) on a global scale. We may want to partner with an existing Certificate Authority to achieve this, although our aim will be to provide verification at a higher level of trust than the existing Certificate Authorities.

A high standard of identity verification can potentially become a very powerful unique sales proposition for us. We hope to influence privacy accreditation requirements with an aim of positioning our solution as a requirement for such accreditation. Achieving that positioning in the market will further drive sales, as companies with strict privacy policies and requirements will need to implement a solution.

5. Free Public Key Server

Public key encryption requires that public keys be accessible. In this example, we provide a free public key server. A public key is found (or if it does not yet exist, is created) on this server for any e-mail address that a user wants to send an e-mail message to. In this example, secret, private keys are also automatically retrieved in the background from a central server by our software.

6. Use “Viral” Adoption Techniques

To use e-mail encryption, you usually need encryption software installed on your computer. (Web-based e-mail systems can be an exception to this.) For public key encryption, each user will also need to have a private key available on his or her computer to decode messages. So even if you send an encrypted message to someone, unless he or she has software available to decrypt the message, and a private key that matches their public key, the message cannot be read.

That can limit the spread of e-mail encryption. If you can only send encrypted messages to people who have a compatible e-mail system already installed on their computers, you are less likely to send encrypted e-mails. At least while most people, as is the case now, do not use encryption software.

In this example, we turn this around. Instead of waiting for people to install encryption software before you can send them an encrypted message, we let users send an encrypted message to people who do not have our plug-in installed. We automatically creating a unique secret key for the recipient based on their e-mail address. FIG. 9 shows an example of how that might work.

To read the message, they need to install our plug-in. In this example, once downloaded, our software automatically installs itself into the users e-mail client. But since our system is free, and simple, people have little reason not to install it.

Now, instead of adoption being limited to a few computer security diehards, adoption spreads like a virus. Once people get exposed to our system by receiving an encrypted-message, they will get the plug-in and have it installed. Having our system installed makes it much more likely that they will send encrypted e-mails to others, in turn exposing them. Adoption spreads virally, which means rapidly.

Ideally, by us eliminating cost and complexity, this viral adoption will result in the system in this example becoming a global standard. The barriers to maximizing user acceptance have come down.

7. Free for the Normal User

In this example, we do not charge fees to a normal user. A user can download our plug-ins without charge. There is also no fee to send encrypted messages and decrypt received messages. FIG. 7 shows an example of what we can provide for free, and what we can provide for a fee.

8. Fees for Upgraded or Ancillary Services

Although we provide basic services for free, we can charge fees for various upgraded or ancillary services. Here are two examples:

a. Identity Verification

In this example, once we have a sufficiently large enough user base, we will offer identity verification for a yearly fee. We will have an application process to identify the person or company using an e-mail address as a trusted user. Those trusted users will be able to have the e-mails they send be identified as being from someone who can be trusted.

For example, when a trusted user sends an e-mail, that status can be shown in our plug-in window, just like the SSL icon in a web browser. We could use a blue icon instead of a red icon on any messages coming from a sender that can be trusted. This would work a little like Yahoo's Domain Keys, a system that filters e-mail delivery based on the known reputation of the sender.

E-mail fraud looms large on the Intemet landscape. As much as 80% of e-mail that says it comes from leading brands, banks and Internet service providers is “spoofed.” It really comes from a fraudulent source, usually someone “phishing” for confidential account information to be used for fraud or hacking. That is according to a report released in late January 2008 by the Authentication and Online Trust Alliance (AOTA).

Identity verification can cut down on that kind of fraud.

b. Faster Responses From Public Key Servers

Companies who send large amounts of e-mail may put a big load on our public key servers. To make sure that this does not result in delays to people who receive and decrypt their messages, a company may want to pay a fee for faster response. In this example, we offer that. We can provide that faster response by specially routing the inquiries that come in to the public key server from a particular server.

Most probably, though, we will do it backwards instead. Rather than treat premium customers better, we will treat non-premium customers worse. That is, we will cut down on queries that repeatedly come from servers asking for more than a certain number of public keys per second unless they have paid for premium service. We can check IP address, session ID, sender's address, the master key they are requesting, whether they are asking for a large number of new public keys, and other things in limiting service.

Those who want more than just a basic, limited volume of service will need to pay for it. The typical e-mail user—one who sends a limited number of e-mails a day (let alone more than one e-mail per second)—gets that for free.

9. Fees for Companies

Individual users may be content with our free service. To download, install and use our e-mail plug-ins will be free to all users.

But companies may want more. Although prices will vary greatly, depending on costs and other factors, the high volume of e-mail use will allow us to charge relatively small fees and still make relatively large amounts of money. We might, for example, want to offer a company a domain-based master key for a few thousand dollars per year. Companies that use multiple domains for e-mail would need to purchase multiple master keys.

For companies who wish to send large volumes of encrypted e-mails, we will provide a premium “key server” service that lets them query large numbers of e-mail addresses, to get their public keys, at a high speed. We could charge for this on a volume basis (say, for example, $1 per 1,000 queries).

We plan to limit the number of replies from our server to queries that originate from one location on our free servers, so companies who want to send out mass (encrypted) mails, will prefer to use our premium service.

Here are two examples of fee-based services for customers:

a. Master Keys

In this example, we offer master keys (domain name based) that allow companies to decrypt and read all encrypted e-mails sent to or from their domain name for a yearly fee. These keys might better be called “pseudo master keys,” since they are a little different from the master keys like a hotel might have a master key that works for all of its rooms. FIG. 8 shows an example of how a master key can work.

Our pseudo master keys can work like this. We create a table on the public key server that has any master key listed alongside the public key for the e-mail address. Then our plug-in will download the master key along with the public key, and use both keys to encrypt the e-mail message. Either private key—the private key for the master key or the private key for the recipient—can be used to decrypt the message.

b. Mass Mailing Systems

In this example, our system will allow companies to send secure, encrypted e-mail to their current members or clients. We use a server-side module that will automatically encrypt e-mails (even if a user has not yet registered with our system). In addition to providing security for sensitive information, users can verify the e-mail came from the company, reducing the risk of phishing attacks.

We can provide mass mailing systems by providing a server-based program that a company could install as a stand-alone program to use instead of personal computer plug-ins. The stand-alone program could send out e-mails on a special port.

We can also offer special hardware for mass mailings. Encryption is computation-intensive. Hardware with beefed-up processors designed specially to handle encryption computations will send out mass mailings with much less effort than normal hardware.

We can also offer the ability for mass mailing customers to cache public keys on their own server.

10. Other Services

We can offer other services as well. We have already explored and confirmed the possibility of compressing data (in addition to encryption). This could be convenient to users who often send attachments, as they could encrypt and compress with the click of just one button within their e-mail client. We are considering the timing and necessity of adding this feature.

We have considered adding e-mail tracking, or “read verification.”Due to the fact that our plug-ins will contact our public key server often, it would be reasonably easy to implement a tracking solution so that when a user decrypts an encrypted e-mail, our public key server could record when, and who decrypted the message. This kind of solution would be beneficial to marketing companies, and others who want confirmation when an e-mail is opened (decrypted).

### THE DRAWINGS

The drawings show one or more examples of e-mail for when risk is not an option. A brief description of each drawing follows:

FIG. 1 shows an example of a public key.

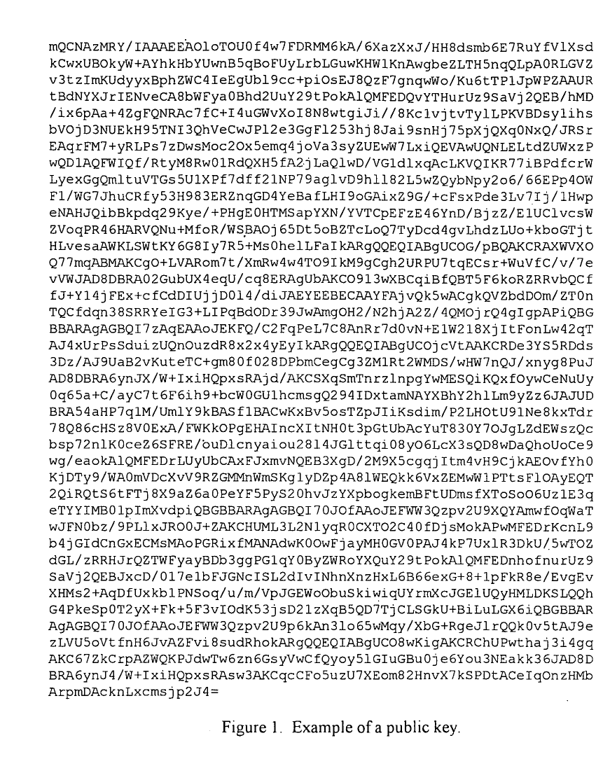

FIG. 2 shows an example of a private key.

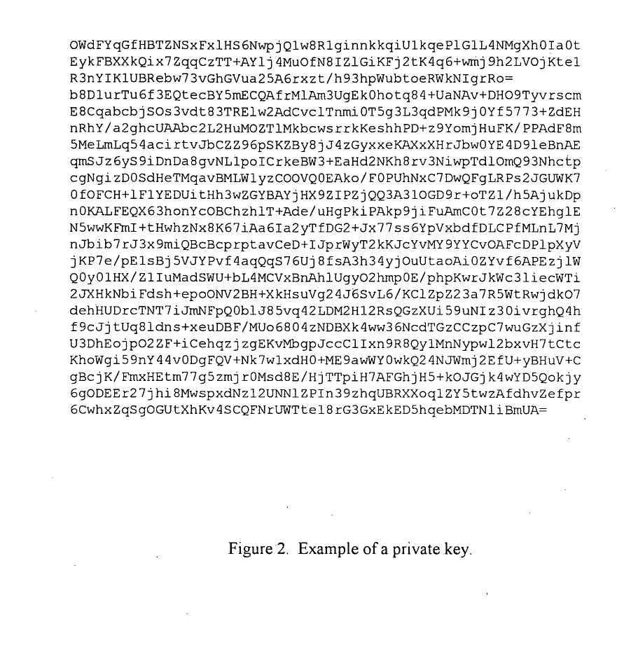

FIG. 3 shows a block diagram of an example of prior art public key encryption and decryption of a message.

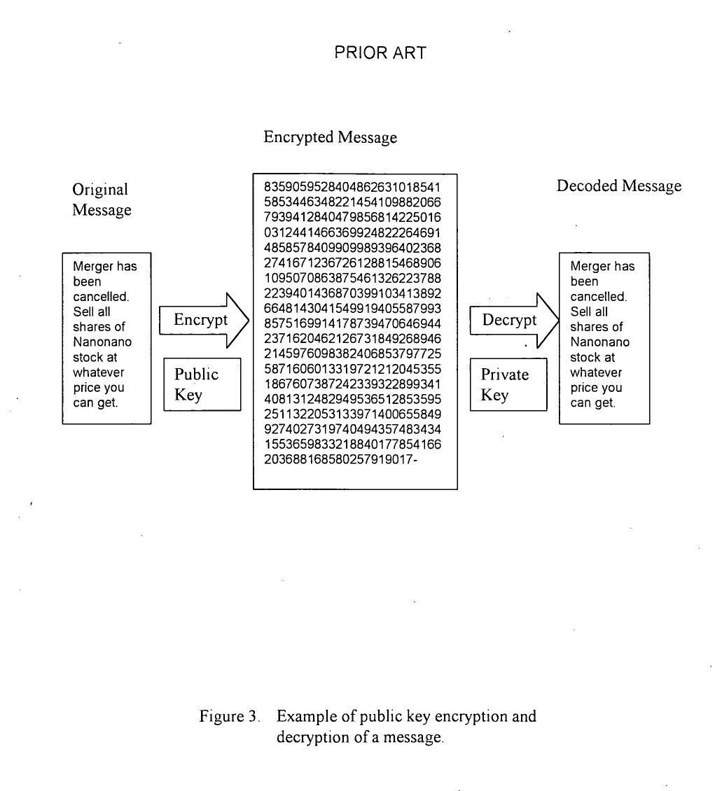

FIG. 4 shows a block diagram of an example of how our system comprises users, software for existing e-mail clients, and a key server.

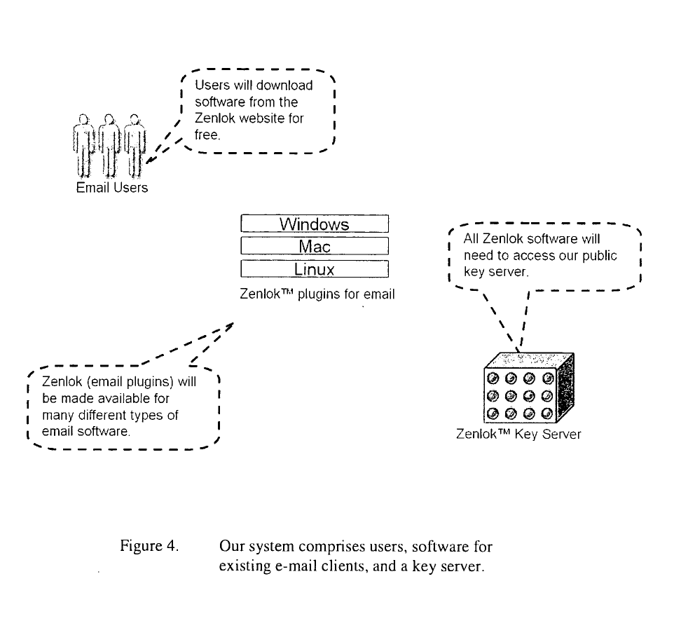

FIG. 5 shows a block diagram of an example of how our technology works in sending an encrypted e-mail message.

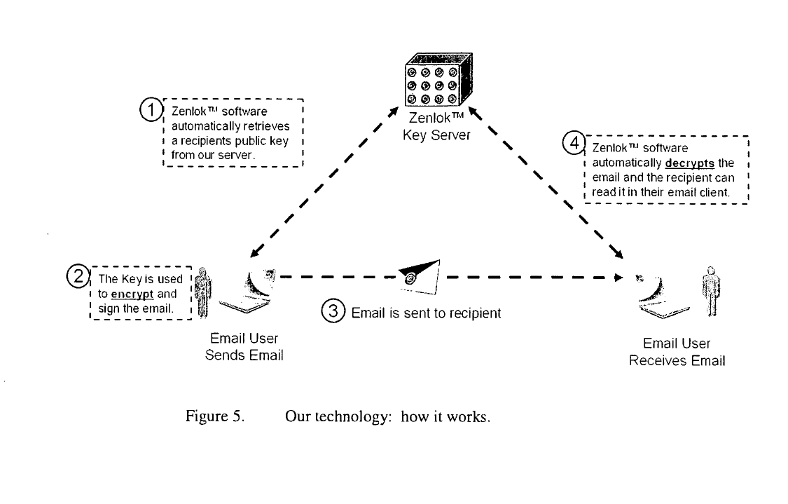

FIG. 6 shows some screen shots of an example of what a user might see in using our system.

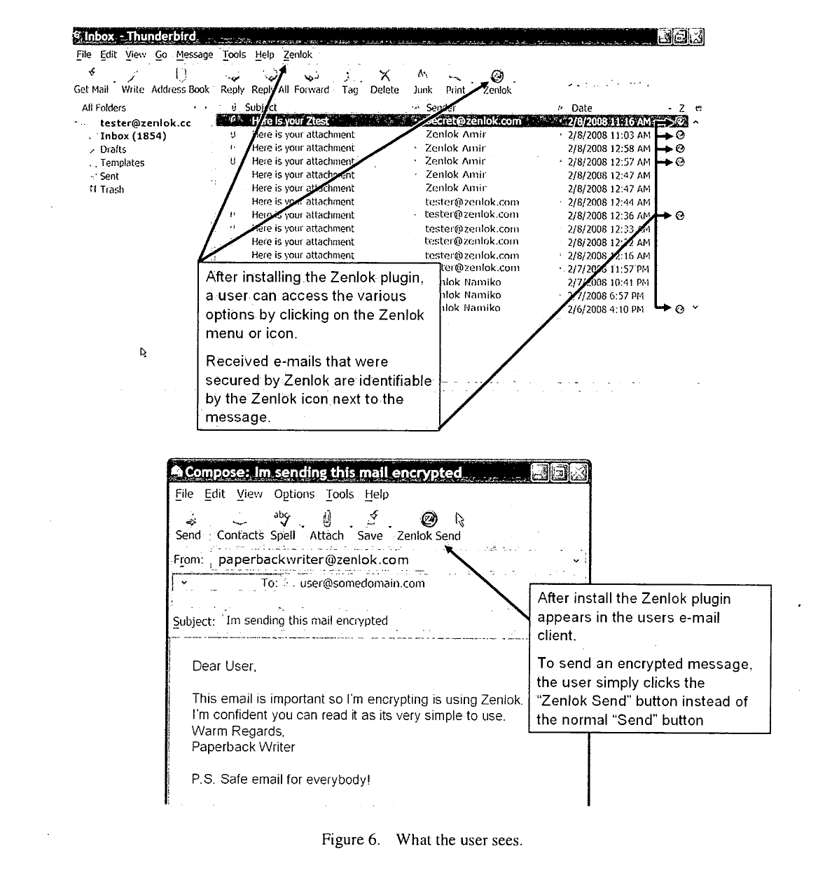

FIG. 7 shows a block diagram of an example of free services versus services for a fee.

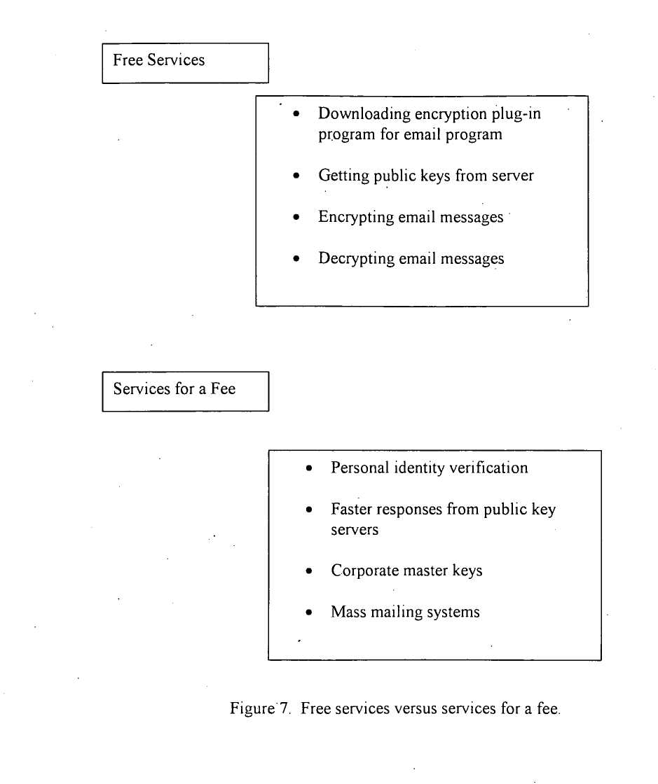

FIG. 8 shows a block diagram of an example of how a master key works.

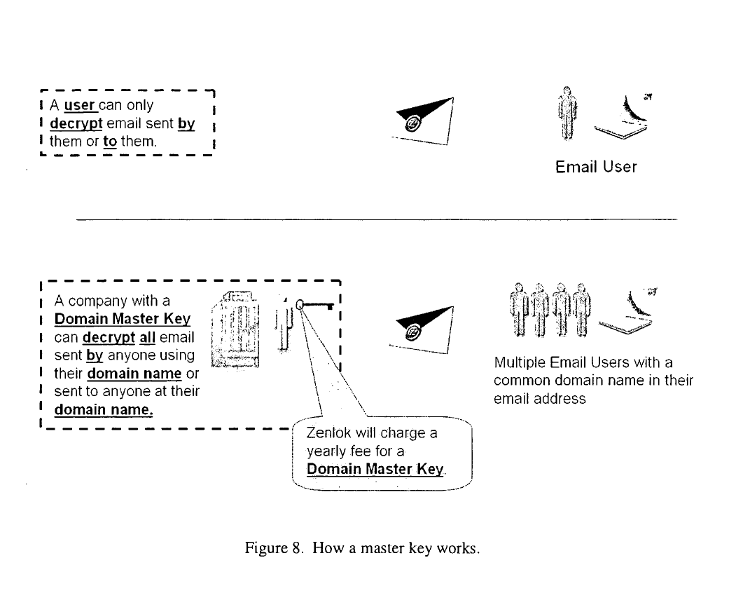

FIG. 9 shows a flow diagram of one example of how to send encrypted e-mail to an unregistered address.

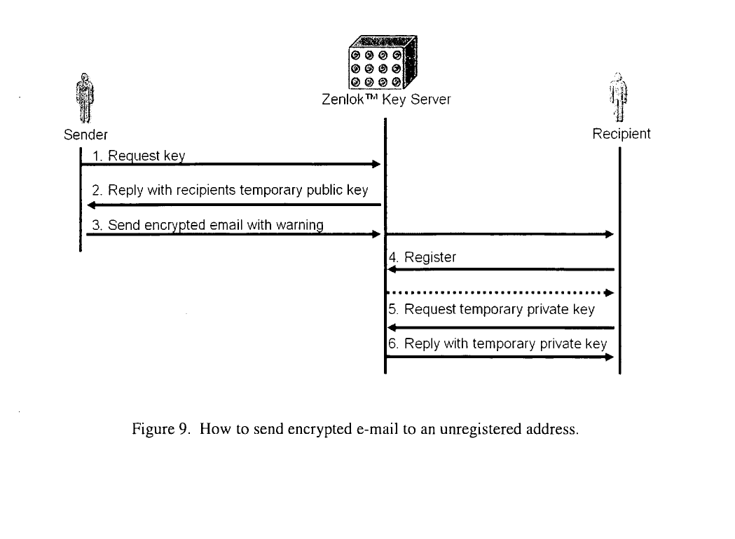

We claim:

1. A system for encrypting and decrypting e-mails where:
any user can download an e-mail encryption program for free, the user can use the program to encrypt and decrypt e-mails for free, and all revenue comes from fees for services and upgrades other than the basic encrypting and decrypting of e-mails.

2. The system of claim 1 where the user can send an encrypted e-mail to a recipient even if the recipient is not already using the encryption program.

3. The system of claim 2 where the recipient of the encrypted e-mail can decrypt it by installing the encryption program even after receiving the message.

4. The system of claim 3 where the recipient only needs to register his or her e-mail address to decrypt the encrypted e-mail, and does not need to create a certificate or a key.

5. The system of claim 1 where the owner or manager of a domain can decrypt all encrypted messages sent from or to e-mail addresses on that domain.

6. The system of claim 1 where adoption of the system by users is spread virally.

7. The system of claim 1 where all encrypting and decrypting takes place in the background.

8. A method for spreading adoption of an e-mail encryption system virally that includes the steps of:
allow a sender to encrypt and send an e-mail to a recipient at any e-mail address, listed on a public key server or not, and
allow the recipient of the e-mail to decrypt it.

9. The method of claim 8 that includes the steps of:
generate a public and private key for any e-mail address not listed on a public key server;
encrypt the e-mail using the generated public key;
send the encrypted e-mail to the recipient;
notify the recipient that the message can be decrypted by downloading a copy of an encryption program;
make the encryption program available at no charge; and
once downloaded, allow the encryption program to retrieve the private key for the recipient and decrypt the message.

10. The method of claim 9 where the private key is a temporary, one-use key that is replaced by a permanent private key when the recipient registers his or her e-mail address.

11. The method of claim 8 where no fee is charged for basic encryption and decryption of e-mail messages to help the system spread virally to become the global standard for e-mail encryption.

12. A system for encrypting and decrypting e-mails using public key/private key encryption, where public keys can be registered on and accessed from an Internet server free of charge.

13. The system of claim 12 where the system also offers one or more of the following services:
identity verification;
faster responses from public key servers;
master keys;
mass mailing systems;
verification of sender;
spam prevention, and
file or disk encryption.

14. The system of claim 12 where all decrypting and encrypting takes place in the background.
